(19) United States
(12) Patent Application Publication
(10) Pub. No.: US 2024/0288268 A1
(43) Pub. Date: Aug. 29, 2024

(54) SHAPE ACQUIRING METHOD, TARGET OBJECT MANAGEMENT METHOD, STEEL FRAME ERECTION METHOD, AND SHAPE ACQUIRING SYSTEM

(71) Applicant: NIKON CORPORATION, Tokyo (JP)

(72) Inventor: Takashi MIYAWAKI, Machida-shi (JP)

(73) Assignee: NIKON CORPORATION, Tokyo (JP)

(21) Appl. No.: 18/573,091

(22) PCT Filed: Jun. 21, 2022
(86) PCT No.: PCT/JP2022/024719

§ 371 Date: Dec. 21, 2023

(30) Foreign Application Priority Data
Jun. 28, 2021 (JP) 2021-106519

(51) Int. Cl. G01B 21/32; G01B 21/22

(52) U.S. Cl. CPC G01B 21/32; G01B 21/22; G01B 2210/58; G01B 2210/60

(57) ABSTRACT

A shape acquiring method that makes it possible to easily obtain information on the shape of a target object without using light includes acquiring information on inclination angles of a target object at a plurality of points using a plurality of inclination sensors attached to the target object (steps S2 and S4) and obtaining shape information of the target object through calculation using the acquired information on the inclination angles at the plurality of points (step S5).

### TECHNICAL FIELD

The present invention relates to a shape acquiring method, a target object management method, a steel frame erection method, and a shape acquiring system, and more specifically relates to a shape acquiring method, a target object management method, and a steel frame erection method using the shape acquiring method which are suitable when at least a part of a structure including, for example, steel members (hereinafter also referred to as a building, a structure, or the like) is a target object and a shape acquiring system which is suitable when at least a part of a structure is a target object.

This application claims priority based on Japanese Patent Application No. 2021-106519 filed Jun. 28, 2021, the content of which is incorporated herein.

### BACKGROUND ART

In the related art, when constructing a construction structure, it is necessary to inspect that construction members that make up columns, walls, or the like are assembled without tilting or distortion. For example, the accuracy of steel erection has been generally measured using a three-dimensional surveying machine that optically measures the position of a target attached to a steel column. However, it is sometimes difficult to perform measurement using surveying machines that use light because there are obstacles or the like at actual construction sites. To overcome this inconvenience, a tilt measuring device that measures the tilt of steel columns using a tilt measuring device (sensor) that does not use light to measure the accuracy of steel erection has been designed (for example, see Patent Document 1).

However, the device described in Patent Document 1 cannot accurately measure the amount of displacement of the column head of a steel column and cannot measure the shape of a steel column, although it can measure the tilt of steel columns during a steel erection process.

### CITATION LIST

### Patent Document

### [Patent Document 1]

Japanese Patent Application, Publication No. 2018-179533

### SUMMARY OF INVENTION

### Solution to Problem

A first aspect of the present invention provides a shape acquiring method for acquiring shape information about a target object, the method including acquiring information on inclination angles of a target object at a plurality of points using a plurality of sensors attached to the target object and obtaining shape information of the target object through calculation using the acquired information on the inclination angles at the plurality of points.

A second aspect of the present invention provides a method of managing a target object, the method including repeatedly performing the shape acquiring method according to the first aspect and monitoring a change in a shape of the target object over time based on shape information obtained each time the shape acquiring method is performed.

A third aspect of the present invention provides a method of erecting a steel frame including a plurality of segment columns, the method including, when individually erecting a plurality of upper segment columns on top of a plurality of lower segment columns erected in a predetermined arrangement, acquiring shape information of one surface extending in a longitudinal direction of each of the plurality of lower segment columns using the shape acquiring method according to the first aspect, obtaining a first amount of positional deviation from a reference of a column head in a direction perpendicular to the one surface of each of the plurality of lower segment columns based on the acquired shape information, and newly determining a target value for erectness of each of the plurality of upper segment columns taking into account the obtained first amount of positional deviation. In this aspect, erectness is a term intending the degree of verticality of the column and the target value for erectness intends a target value of the degree of verticality of the column, or a target value of inclination angle.

A fourth aspect of the present invention provides a method of erecting a steel frame including a plurality of segment columns, the method including, when individually erecting a plurality of upper segment columns on top of a plurality of lower segment columns erected in a predetermined arrangement, connecting the plurality of lower segment columns and the plurality of upper segment columns respectively, by using a plurality of erection jigs respectively, acquiring shape information of a first surface and a second surface extending in a longitudinal direction and intersecting each other of each of the plurality of upper segment columns using the shape acquiring method according to claim 4, and controlling, by a control device, a plurality of drive devices individually provided for the plurality of erection jigs in parallel based on the acquired shape information of the first surface and the second surface of each of the plurality of upper segment columns to automatically adjust positions of column heads of the plurality of upper segment columns.

A fifth aspect of the present invention provides a shape acquiring system for acquiring shape information of a target object, the shape acquiring system including an analysis device and a terminal device connected to each other via a wide area network, and a plurality of sensor devices each connected to the terminal device via a communication line, the plurality of sensor devices being attached to different positions on the target object when used, each of the plurality of sensor devices being configured to output sensor data including information on an inclination angle at a corresponding attachment position via the communication line, wherein each of the plurality of sensor devices is configured to output the sensor data based on an external command or at a predetermined time, the terminal device is configured to transmit the sensor data output from each of the plurality of sensor devices to the analysis device via the wide area network, and the analysis device is configured to obtain shape information of the target object through calculation using the information on the inclination angle included in the plurality of pieces of sensor data received via the wide area network and store the obtained shape information in a storage.

Here, the communication line and the wide area network may be parts of the same network.

### BRIEF DESCRIPTION OF DRAWINGS

FIG. 1 is a diagram schematically showing an overall configuration of a shape acquiring system according to a first embodiment for implementing a shape acquiring method.

FIG. 2 is a block diagram showing an example of a configuration of a sensor device in FIG. 1.

FIG. 3 is a partially omitted perspective view showing a steel building including a large number of steel columns which are target objects for shape measurement.

Part (A) of FIG. 4 is a side view showing a sensor device fixed to a steel column and part (B) of FIG. 4 is a bottom view showing the sensor device.

FIG. 5 is a flowchart showing a process of a shape acquiring method according to the present embodiment.

FIG. 6 is a diagram showing a column selected as a measurement target and three sensor devices attached to the column, which is used to explain the shape acquiring method according to the present embodiment.

FIG. 7 is a flowchart showing a processing algorithm executed by a CPU of an arithmetic processing unit in the sensor device.

FIG. 8 is a flowchart showing a processing algorithm of an interrupt processing routine executed by a CPU of a server.

FIG. 9 is a diagram for explaining the meaning of inclination angles output from sensor devices.

FIG. 10 is a diagram for explaining a method of calculating the shape of a measurement surface (a first surface) of a column 100₁ to which sensor devices 18₁ to 18₃ are attached.

FIG. 11 is a diagram showing an example in which sensor devices are arranged at the same heights on two orthogonal surfaces extending in the longitudinal direction of a column.

FIG. 12 is a diagram showing an example of a configuration of a system for implementing a method of erecting a steel frame.

FIG. 13 is a diagram for explaining erection jigs, which shows the erection jigs in a state where erection pieces 102a of a column 100ₘ, and erection pieces 102b of a column 100ₙ are connected.

FIG. 14 is a diagram showing the erection jigs assembled to the erection pieces 102a at a column head of the column 100ₘ, with the erection jigs in an open state.

FIG. 15 is a flowchart showing a process flow of a method of erecting nth segment columns.

FIG. 16 is a diagram for explaining steel beam members.

FIG. 17 a diagram for explaining new setting of a target value for erectness of a second segment column for canceling the amount of positional deviation in an X axis direction of a column head of a first segment column when the second segment column is erected on top of the first segment column.

### DESCRIPTION OF EMBODIMENTS

### First Embodiment

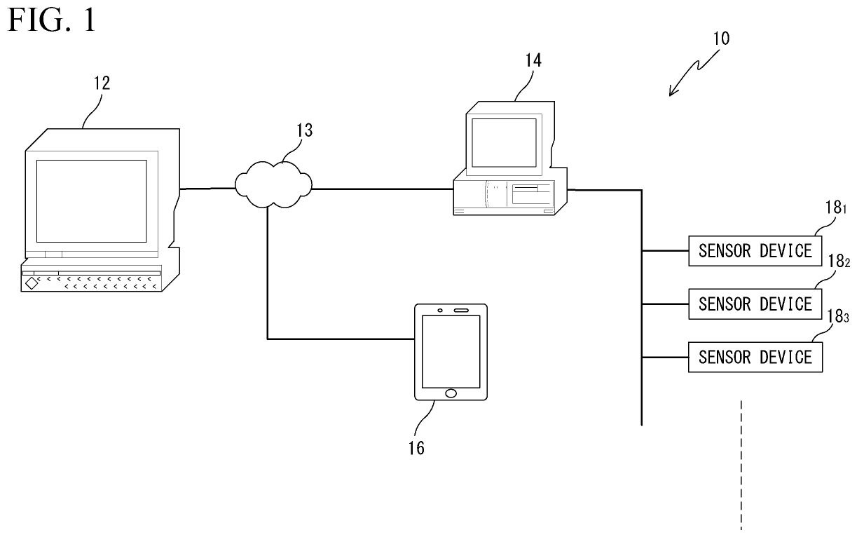

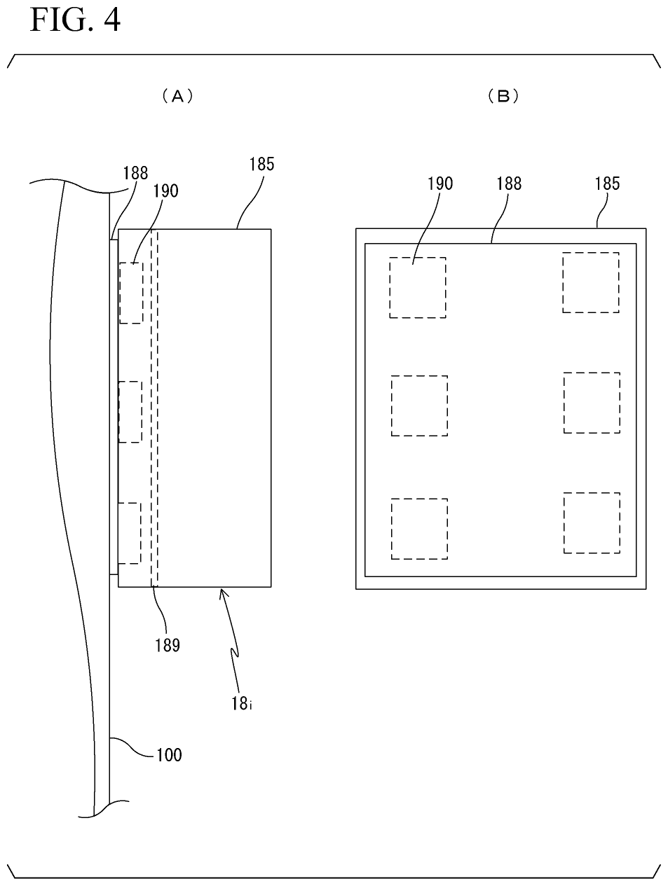

A first embodiment will be described below based on FIGS. 1 to 11. The case where a target object is a steel column 100 included in a steel building 110 shown in FIG. 3 will be described as an example, but the target object is not limited to a steel column. In the following description, it is assumed that a vertical direction (a gravity direction) is a Z axis direction, and within a plane orthogonal to the Z axis, a left-right direction in the paper plane of FIG. 3 is an X axis direction and a direction orthogonal to the Z and X axes is a Y axis direction as shown in FIG. 3, and directions of inclination (rotation) around the X axis, Y axis, and Z axis are θx, θy, and θz directions, respectively.

FIG. 1 schematically shows an overall configuration of a shape acquiring system 10 according to a first embodiment for implementing a shape acquiring method. The shape acquiring system 10 includes a server 12 that also functions as an analysis device, an on-site controller 14 and a mobile terminal 16 that also function as a terminal device, and a plurality of sensor devices 18ᵢ (where i=1, 2, 3, . . . ) connected to the on-site controller 14 via communication lines, for example, wireless LANs, which are connected to each other via a wide area network (hereinafter abbreviated as a network) 13 such as the Internet. In FIG. 1, three sensor devices 18₁ to 18₃ are representatively shown among the plurality of sensor devices 18ᵢ. The communication lines may all be wireless or may be at least partially wired. The terminal device 14 does not necessarily need to be provided and outputs of the plurality of sensor devices 18ᵢ may be directly provided to the server 12 via the network 13. That is, the communication lines and the wide area network 13 may be parts of the same network. The terminal device may not include the on-site controller and may only be a mobile PC or a smartphone.

In the present embodiment, a commonly used server computer is used as the server 12, but a cloud (computer) may also be used. The server 12 includes a CPU, a ROM, a RAM, an HDD (storage), and the like (not shown) and the CPU uses, for example, the RAM as a work area and executes various processing algorithms defined by various programs stored in the ROM, the HDD, or the like. The configuration of the server 12 which also functions as an analysis device is not limited to that of the present embodiment and it is sufficient to include at least a component (or a function) that can obtain shape information of the target object (the steel column 100) through calculation based on the outputs of the plurality of sensor devices 18ᵢ. The analysis device is not limited to hardware as in the present embodiment and may be software that can execute at least, for example, an arithmetic function.

As will be described later, upon receiving sensor data (including an ID) from the on-site controller 14 via the network 13, the server 12 executes a process of an interrupt processing routine that will be described later and obtains shape information of a part of a target object (a measurement target). The process of the interrupt processing routine will be described in detail later.

The on-site controller 14 is a commonly used computer in the present embodiment. The on-site controller 14 internally includes, for example, a CPU, a ROM, a RAM, and an HDD (not shown) and the CPU uses the RAM as a work area and executes a processing algorithm defined by a program stored in the ROM, the HDD, or the like. The on-site controller 14 includes operating units such as a keyboard and a mouse and a display screen such as a liquid crystal display. In the present embodiment, the on-site controller 14 performs data communication with the server 12 and the mobile terminal 16 via the network 13 in response to an instruction that a site supervisor or other manager has input through an operating unit. When a plurality of pieces of sensor data is received from a plurality of sensor devices 18 via a communication line as will be described later, the on-site controller 14 extracts sensor data regarding the same target object from the plurality of pieces of sensor data and groups together the extracted sensor data (for example, links them using the same ID) and transmits it to the server 12.

The mobile terminal 16 is carried by a worker at a construction site. The mobile terminal 16 is a commonly used portable computer such as, for example, a tablet PC. The mobile terminal 16 may also be a smartphone.

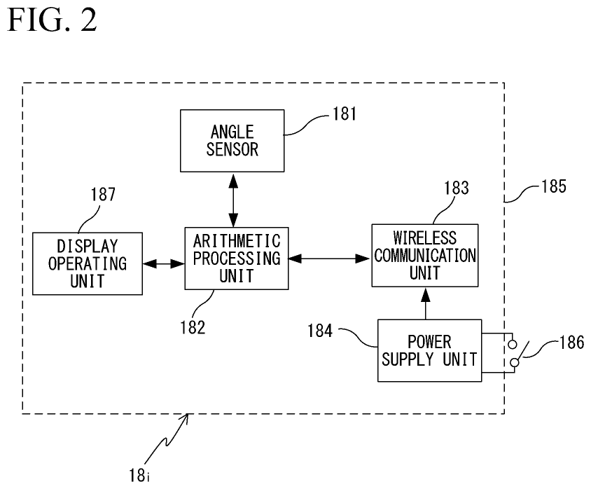

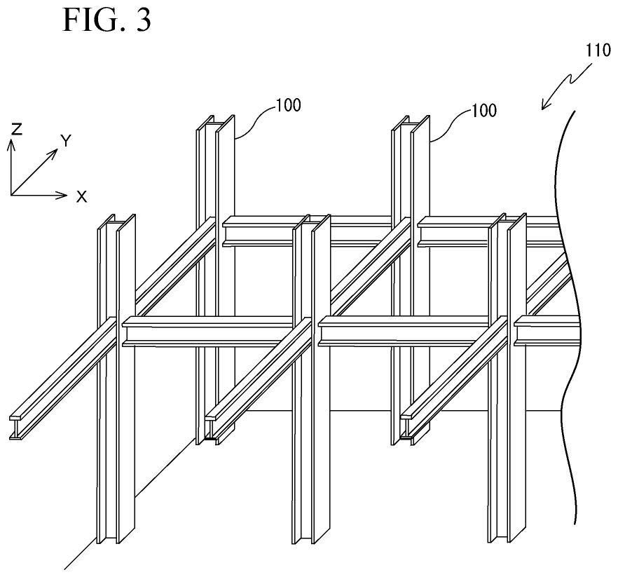

As shown in FIG. 2, each of the sensor devices 18ᵢ includes an angle sensor 181, an arithmetic processing unit 182, a wireless communication unit 183, a power supply unit 184 made of, for example, a battery, and a waterproof housing 185 inside of which these are housed. The supply of power from the power supply unit 185 to each component of the sensor device can be turned on and off by operating a power switch 186 provided on the housing 185. The communication unit 183 is not necessarily wireless and at least a part thereof may be wired. The sensor device 18ᵢ does not necessarily need to be provided with the power switch 186 and may be configured such that it can be powered on and off by an operation from the outside (the server 12, the on-site controller 14, or the like). The configuration of the sensor device 18ᵢ is not limited to that of the present embodiment, the angle sensor 181, the communication unit 183, and the like do not have to be integrated, and the sensor device 18ᵢ need only include at least the angle sensor 181, that is, a function of measuring angle information of an installation location of the sensor device 18ᵢ. For example, the angle sensor 181 and other components (including the arithmetic processing unit 182 or the like) may be connected via a wireless or wired communication line and sensor data output from the angle sensor 181 and power supply to the angle sensor 181 may be performed via the communication line. In this case, it is not necessary to provide the other components for each angle sensor 181 and a plurality of angle sensors 181 may be connected to the same other components via the communication line. The on-site controller 14 may have the functions of the other components.

In the present embodiment, three-dimensional microelectromechanical systems (3DMEMS) inclination angle sensors are used as the angle sensors 181 as an example. A 3DMEMS inclination angle sensor is a precision inclination sensor created using 3DMEMS technology and is also simply referred to as a 3DMEMS sensor below. The power requirement of 3DMEMS inclination angle sensors is power consumption in a microampere range which is extremely low, making them suitable for wireless applications. The angle sensor 181 is one that incorporates two MEMS acceleration sensors with symmetrical output characteristics and an ASIC and outputs, for example, information on inclination angles (α, β, γ) in the three directions (θx, θy, and θz directions). The angle sensor is not limited to the 3DMEMS inclination angle sensor and other types of three-dimensional inclination angle sensors may be used. The angle sensor is not limited to a three-dimensional inclination angle sensor and a two-dimensional inclination angle sensor or a one-dimensional inclination angle sensor may be used depending on the target object to be measured. Here, a two-dimensional inclination angle sensor and a one-dimensional inclination angle sensor may be combined or a plurality of two-dimensional or one-dimensional inclination angle sensors may be used in combination.

The arithmetic processing unit 182 is composed of, for example, a microcontroller (MCU) and includes a CPU, a memory device (a RAM and a ROM), an input/output circuit, and a timer circuit (not shown). The arithmetic processing unit 182 executes a processing algorithm defined by a program stored in the ROM. Rather than providing the arithmetic processing unit 182, the ASIC built in the angle sensor 181 may also have the function of the arithmetic processing unit 182.

Here, an example of a structure for attaching sensor devices 18 to a steel column (hereinafter abbreviated as a column as appropriate) will be described. Part (A) of FIG. 4 shows a side view of a sensor device 18ᵢ fixed to the column 100. Part (B) of FIG. 4 shows a bottom view of the sensor device 18ᵢ.

As shown in parts (A) and (B) of FIG. 4, a plate-shaped cushion member 188 made of, for example, urethane, silicone, rubber, or felt is attached to the bottom surface of the housing 185. A plurality of recesses, for example, six recesses, are formed in the bottom of the housing 185 facing the cushion member 188 and a permanent magnet 190 is disposed in each recess. The sensor device 18 is attached to the column 100 via the cushion member 188 by the magnetic force of the plurality of permanent magnets 190. This can effectively prevent the occurrence of an inclination error when attaching the sensor device 18ᵢ, without being affected by irregularities on the attaching surface of the column 100 caused by rust or the like. A magnetic shield member 189 is provided near the bottom of the housing 185. The number and shape of the permanent magnets are not particularly limited and the shape of the recesses formed at the bottom of the housing 185 may be any shape that allows the permanent magnets to be placed therein. The cushion member 188 may not necessarily be provided depending on the flatness of the installation surface of the column to which the sensor device 18ᵢ are attached.

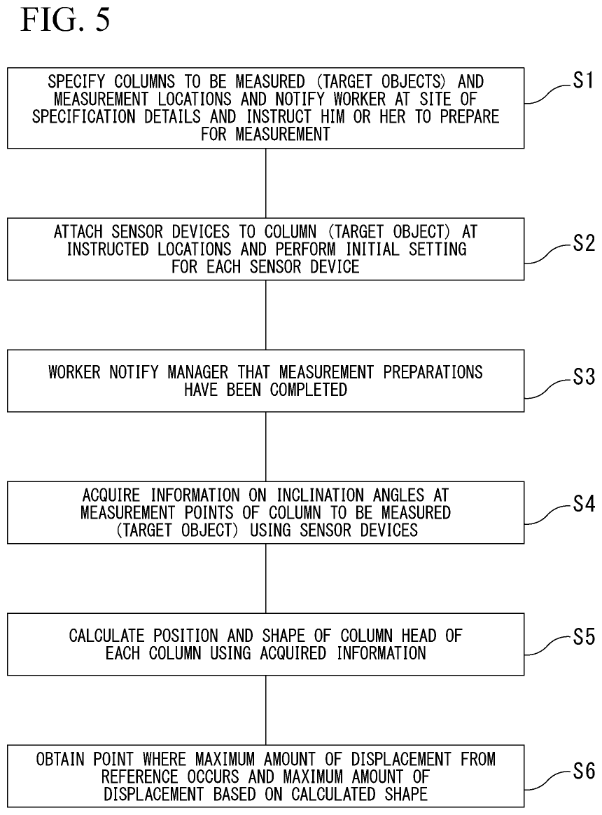

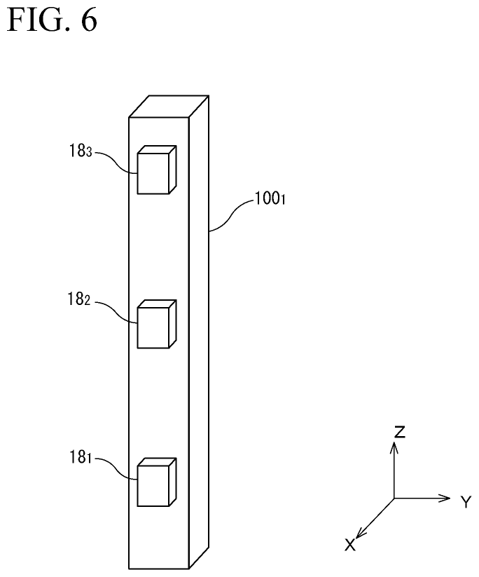

Next, a process of a shape acquiring method according to the present embodiment will be described based on a flowchart of FIG. 5. Sensor devices 18ᵢ are attached to a column selected as a measurement target from many columns that constitute the steel building 110 shown in FIG. 3. In the following, one column 100₁ and three sensor devices 18₁ to 18₃ attached to the column 100₁ shown in FIG. 6 will be discussed as appropriate. In FIG. 6, the three sensor devices 18₁ to 18₃ are arranged from bottom to top on an +X side surface (hereinafter also referred to as a first surface or measurement surface) of the column 100₁.

As a premise, it is assumed that the server 12 stores blueprint data or the like of the steel building 110 in a storage (such as an HDD) through communication between the server 12 and the on-site controller 14 via the network 13. The server instructs the on-site controller 14 about conditions that are prerequisites for measurement based on the blueprint data. These conditions include the number of sensor devices to be attached to the column to be measured, the attachment positions, and the like.

First, a manager at the site such as a site supervisor specifies columns to be measured and measurement locations (also referred to as measurement points) via the on-site controller 14 in response to an instruction from the server and notifies a worker at the site of the specification details by email or the like and instructs the worker to prepare for measurement (step S1 in FIG. 5). The content of the instruction is also displayed on a display screen of the mobile terminal 16. Here, the columns are specified using column numbers (001, 002, . . . ) and the measurement locations are specified using numbers (01, 02, . . . ) in order from the bottom. Each measurement location is determined such that, for example, its distance from the base of the column is a predetermined value when the column is erected. In the present embodiment, an instruction is given to the worker at the site via the on-site controller 14, but the work instruction may also be sent from the server 12 to the mobile terminal 16 held by the worker via the network 13. In this case, it is desirable that the manager input the specification details such as measurement points into the server 12 in advance.

The worker at the site who has checked the content of the instruction in the email or the like sequentially attaches the sensor devices 18ᵢ to the column 100ⱼ to be measured at the measurement locations thereof in accordance with the instruction and performs initial setting for each attached sensor device 18ᵢ (step S2 in FIG. 5). Here, it is assumed that each sensor device 18ᵢ has been calibrated in advance such that no measurement errors occur. Each sensor device 18ᵢ is also configured in advance with necessary settings such that it can communicate with the on-site controller 14 via a communication line (a wireless LAN). However, after the setting, the switch 186 is temporarily set to OFF. Here, in the present embodiment, the sensor devices 18ᵢ are attached to the column 100ⱼ with one touch using magnetic force as described above. The sensor devices 18ᵢ may also be attached to the column 100ⱼ with the switch 186 being ON (in an ON state).

The initial setting of the sensor device 18ᵢ described above includes turning on the switch 186 of the sensor device 18ᵢ and inputting identification information of the sensor device 18ᵢ via a display operating unit 187. For example, identification information (001-01), (001-02), and (001-03) are input respectively to the three sensor devices 18₁, 18₂, and 18₃ shown in FIG. 6 and their arithmetic processing units 182 store the input identification information in internal memories (RAMs). This causes the sensor devices 18ᵢ to enter a standby state in which they can perform measurement at any time. If the sensor device 18ᵢ is attached while in an on state, the operation of the switch 186 is not necessary.

When the attachment and initial setting of all sensor devices used for measurement are completed, the worker at the site notifies a manager such as the site supervisor by email or the like that the instructed measurement preparations have been completed (step S3 in FIG. 5).

Next, information on inclination angles at the measurement points of the column 100ⱼ to be measured is acquired using the sensor devices (step S4 in FIG. 5).

When the acquisition of the information on the inclination angles at the measurement points of the column to be measured (that is, the column as a target object) is completed, the position and shape of the column head of each column to be measured are calculated using the acquired information on the inclination angles (step S5 in FIG. 5). In the present embodiment, it is assumed that a two-dimensional shape (a shape in the XZ plane) of one surface of the column on which the sensor devices are attached is calculated as the shape of the column.

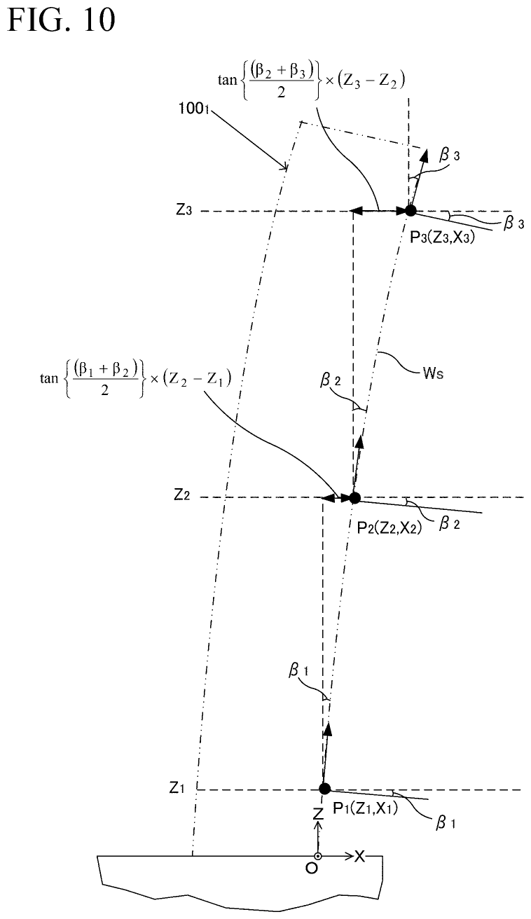

When the calculation of the shape of the column is completed, the amount of displacement of the column head from a reference (see the Z axis of FIG. 10), a point where a maximum amount of displacement of the column head from the reference (corresponding to the amount of deflection of the column) occurs, and the maximum amount of displacement are obtained based on the calculated shape (step S6 in FIG. 5).

In the present embodiment, the steps S4 to S6 are performed by the shape acquiring system 10 and thus the operation of each component of the shape acquiring system 10 will be described below.

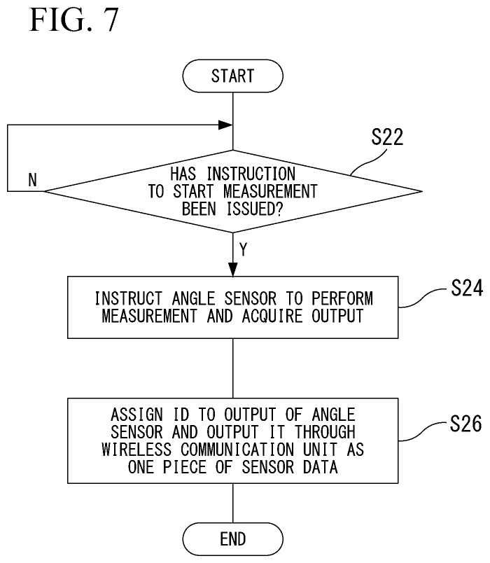

First, the operation of each sensor device used in the process of step S4 will be described based on the flowchart of FIG. 7. This flowchart shows a processing algorithm defined by a program that is executed by the CPU of the arithmetic processing unit 182. For convenience, it is assumed that the processing algorithm shown in the flowchart of FIG. 7 starts when the initial setting of each sensor device described above is completed.

First, in step S22, the CPU of the arithmetic processing unit 182 waits for a measurement start instruction to be input. The measurement start instruction is input by the manager via the on-site controller 14. Because the manager can recognize that measurement preparations have been completed by receiving the notification from the worker that the measurement preparations have been completed in step S3, the manager inputs an instruction for each sensor device 18ᵢ to start measurement to the on-site controller 14 via an operating unit at an appropriate time after that time.

Then, the process proceeds to step S24 when the measurement start instruction has been input from the on-site controller 14 via the communication line and the wireless communication unit 183. In step S24, the angle sensor 181 is instructed to perform measurement and information on the inclination angle (of at least one of up to three axes) measured by the angle sensor 181 is acquired.

In the next step S26, the acquired output information is assigned an ID (an identification code) and transmitted as one piece of data to the on-site controller 14 via the wireless communication unit 183. Here, a number (a code) created based on identification information that is input by the worker at the time of initial setting and stored in the RAM is used as the ID. For example, numbers (codes) corresponding to identification information 001-01, 001-02, and 001-03 are created as IDs respectively for the sensor devices 18₁, 18₂, and 18₃.

When the process of step S26 is completed, the process ends. This causes the sensor devices 18 to enter a standby state until the next measurement start instruction is input.

The process from steps S22 to S26 described above is performed by all sensor devices 18ᵢ.

The on-site controller 14 sequentially stores received sensor data in a predetermined storage area of the RAM. When a plurality of pieces of sensor data are received simultaneously, the on-site controller 14 stores the pieces of sensor data simultaneously in a predetermined storage area of the RAM by time-sharing processing.

When sensor data for three measurement points at the top, middle, and bottom of the same column is collected, the on-site controller 14 transmits it to the server 12 via the network 13 as newly stored data. For example, regarding the column 100₁, three pieces of data including IDs corresponding to the identification information 001-01, 001-02, and 001-03 are transmitted to the server 12 in a batch.

When transmitting data to the server 12, the on-site controller 14 may display identification data of the column corresponding to the transmitted data on the display screen.

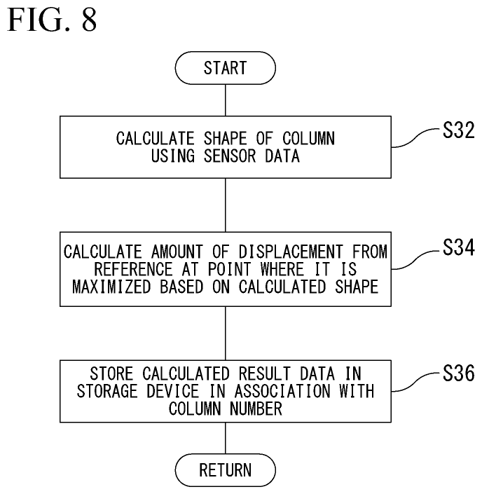

Next, the operation of the server used in the process of steps S5 and S6 will be described based on the flowchart of FIG. 8. This flowchart shows a processing algorithm of an interrupt processing routine defined by a program, which is executed by the CPU of the server 12.

This interrupt processing routine is executed, for example, each time the acquisition of sensor data sent from the on-site controller 14 is completed. The time when the interrupt processing routine is executed is not limited to this and the interrupt processing routine may be executed at the time when sensor data has been acquired a plurality of times.

First, in step S32, data on the shape of the column 100ⱼ is calculated using the acquired sensor data.

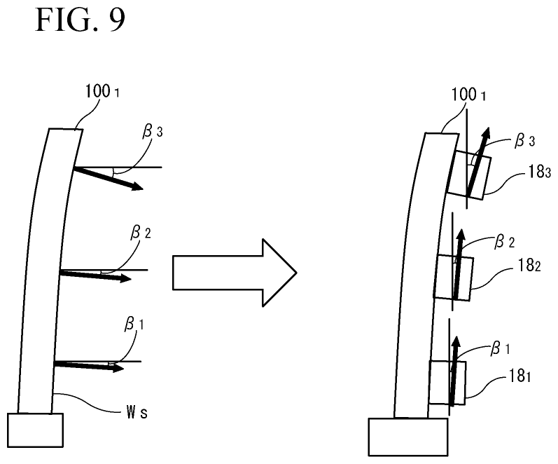

Here, an example of a method for calculating the shape of a column will be described. Here, the case where the shape in the XZ plane of the first surface (hereinafter referred to as a measurement surface Ws) of the column 100₁ to which the sensor devices 18₁ to 18₃ are attached is calculated will be briefly described as an example. Here, the shape in the XZ plane will be discussed because the three sensor devices 18₁ to 18₃ are arranged on the measurement surface Ws of the column 100₁ in the vertical direction. Because the sensor devices 18ᵢ each include an angle sensor 181 made of a 3DMEMS sensor, the sensor devices 18ᵢ output the inclination angles βᵢ of normal vectors to the measurement surface Ws at the measurement points shown on the left side of FIG. 9 as inclinations of the sensor devices 18ᵢ (angles with respect to the axis in the direction of gravity) as shown on the right side of FIG. 9. Thus, there is no need to set references as in measurement or the like using a three-dimensional surveying machine in the related art.

When the sensor devices 18₁, 18₂, and 18₃ are represented respectively by points P₁, P₂, and P₃ and the positions on the measurement surface Ws where the sensor devices 18₁, 18₂, and 18₃ are attached are indicated respectively by P₁(X₁, Z₁), P₂(X₂, Z₂), and P₃(X₃, Z₃) as shown in FIG. 10, the X position X₂ of the point P₂ and the X position X₃ of the point P₃ can be obtained through calculation as follows. It is assumed that the origin of an XZ coordinate system is set at a lower end point of the measurement surface Ws whose shape is to be determined.

$${X}_{2} = {X}_{1} + tan \{ ( {β}_{1} + {β}_{2} ) / 2 \} \times ( {Z}_{2} - {Z}_{1} ) … \qquad ( 1 )$$

$${X}_{3} = {X}_{2} + tan \{ ( {β}_{2} + {β}_{3} ) / 2 \} \times ( {Z}_{3 -} {Z}_{2} ) … \qquad ( 2 )$$

In FIG. 10 (and FIG. 9), in particular, the inclination angle β₁ measured by the sensor device 18₁ is shown larger than it actually is in order to make the explanation visually easy to understand. In reality, because the inclination angle β₁ is very small, the X position X₁ of the point P₁ is X₁≈Z₁ tan β₁≈0, and by substituting this into equation (1), X₂ can be calculated from the known values Z₂, Z₁, β₁, and β₂, and then X₃ can be calculated from the known values X₂, Z₂, Z₃, β₂, and β₃ by substituting the obtained X₂ into equation (2).

Next, the shape of the measurement surface Ws in the XZ plane can be obtained by fitting the obtained points P₁(X₁, Z₁), P₂(X₂, Z₂), and P₃(X₃, Z₃) using an appropriate function.

Although the description so far has been with regard to the case where three sensor devices 18ᵢ are arranged on the measurement surface in the vertical direction, it is also conceivable that the sensor devices 18ᵢ are two-dimensionally arranged on the measurement surface. In particular, when a measurement surface of a target object is a three-dimensional curved surface, it is necessary to two-dimensionally arrange sensor devices on the measurement surface. However, in reality, because the sensor devices 18ᵢ output the inclination angles (three-dimensional inclination angles) of the normal vectors to the measurement surface Ws, it is also possible to derive the shape (the surface shape) of the measurement surface of the target object from the coordinates of the measurement points and the measured values of the normal vectors. For example, the shape may be calculated by obtaining the height of each measurement point relative to a reference plane using the surface slope of each measurement point and its first-order integral or the shape of the target object may be calculated based on a function obtained by changing a function obtained by fitting gradient distribution data obtained from a plurality of pieces of data regarding the same target object obtained through measurement into an integral system. For example, a function such as differential Zernike can be used as a fitting function. Actual measured values of the coordinates and normal vectors of a finite number of discrete measurement points on a measurement surface of a target object may also be used to calculate the shape, for example, by optimizing the order and coefficients of a Fourier series expansion such that the error at each measurement point of an approximated surface expressed by the Fourier series expansion is minimized. Further, the shape acquiring method according to the present embodiment can use various other methods using various functions as long as it is possible to calculate the shape using inclination angles at a plurality of measurement points.

Returning to the description of FIG. 8, in the next step S34, the amount of displacement of the column head from the reference (the Z axis here), a point where a maximum amount of displacement from the reference occurs, and the maximum amount of displacement (corresponding to the maximum amount of deflection of the column) are obtained based on the calculated shape.

In the next step S36, the obtained data (data on the shape, the amount of displacement of the column head, the point where a maximum amount of displacement occurs, and the maximum amount of displacement) is stored in a storage (such as an HDD) in association with the column number and then the interrupt processing routine is exited.

In the present embodiment, the interrupt processing routine shown in FIG. 8 is performed each time sensor data of a column (a target object) is acquired. That is, the calculation of the shape, the calculation of the amount of displacement of the column head and the maximum amount of displacement (corresponding to the maximum amount of deflection), and the storage of the calculation result associated with the column number (the target object number) are performed repeatedly each time sensor data is acquired for each of all columns (target objects) to be measured. Therefore, a rewritable data table that is associated with the target object number (column number) may be prepared in advance in a predetermined area of the storage and an area associated with the target object number (column number) may be repeatedly overwritten (that is, the stored content may be updated) when the calculation result is stored. Further, each time a data table is created and updated as table data in which latest information stored in the storage is associated with design data, the server device 12 may transmit the table data to the on-site controller 14 via the network 13. In this case, the on-site controller 14 may use and store the received table data in a storage device such as a RAM or HDD to create and update a database.

In this case, it is also possible to monitor changes in the shape of the target object (column) over time or the like based on the created and updated database. It is also possible to calculate the strength based on the shape and calculate a stress generated in the target object (column).

It is necessary to supply power to each sensor device when performing monitoring of changes over time over a long period of time or the like. For example, power supply using a MEMS vibration generator, wireless power transfer (non-contact power transfer) which transmits power using an induced magnetic flux generated through electromagnetic induction between the power transmission side and the power reception side, solar power generation, wired LAN power transfer using LAN cables, or the like can be performed as a countermeasure against such situations.

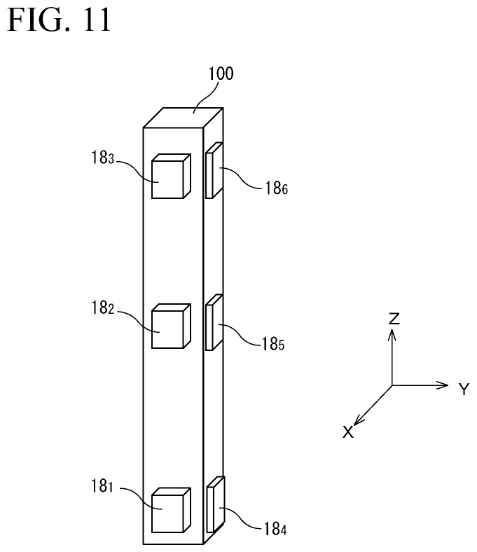

In the present embodiment, sensor devices 18ᵢ may be arranged on two orthogonal surfaces extending in a longitudinal direction of the column 100 (a first surface perpendicular to the X axis and a second surface perpendicular to the Y axis) at positions at the same heights as shown in FIG. 11.

For example, it is assumed that sensor devices 18₁, 18₂, and 18₃ are arranged on the first surface and sensor devices 18₄, 18₅, and 18₆ are arranged on the second surface. In this case, the shape of the first surface may be obtained based on outputs of the sensor devices 18₁, 18₂, and 18₃ and information on the shape of the second surface may be obtained based on outputs of the sensor devices 18₄, 18₅, and 18₆ through the interrupt processing routine described above.

Here, even when only the sensor devices 18₁, 18₂, and 18₃ are attached to the first surface, it is theoretically possible to determine the shape of the second surface since each sensor device outputs a three-dimensional inclination angle. However, in reality, sensor devices may have rotation errors around normal lines to the attaching surface when being attached thereto and thus it is desirable that sensor devices be attached to both the first and second surfaces when it is desired to know the shape of the first surface and the shape of the second surface. In addition, the results of measuring the first and second surfaces with an existing surveying machine may be set as initial values and fluctuations from the results may be continuously measured with a sensor attached to the first surface and then used as the results of fluctuations of the first and second surfaces.

According to the shape acquiring method according to the present embodiment, by performing a predetermined calculation using information on inclination angles at a plurality of measurement points of a column acquired by a plurality of sensor devices attached to the column, it is possible to obtain the shape of a part of the target object, for example, a surface (a measurement surface) to which the sensor devices are attached, and eventually the shape of the column, the maximum amount of displacement from a reference surface over the entire measurement area, and the like as described above. This makes it possible to obtain the shape of the column without using light, eliminates the need for a three-dimensional measuring machine or the like that uses light, and eliminates the influence of obstacles or the like, if any.

Repeatedly acquiring the shape of the measurement surface, the shape of columns, the maximum amount of displacement, and the like enables management (management of absolute values and/or management of changes over time) of columns. In particular, when the shape acquiring method is performed according to the present embodiment using the shape acquiring system 10 according to the embodiment described above, it is possible to remove the measurement preparation process and enable automatic acquisition of the shape of the measurement surface and eventually the acquisition of the shape of the column, the acquisition of the amount of displacement from the reference over the entire measurement area, and the management (management of absolute values and/or management of changes over time) of columns. Thus, according to the shape acquiring system 10 according to the embodiment described above, it is possible to eliminate manual surveying work in steel constructions, thereby alleviating the labor shortage and shortening the construction period of steel constructions.

According to the shape acquiring method according to the present embodiment, it is also possible to perform adjustments of exterior panels using a jig in a factory or the like because the shape of a measurement surface of a steel column can be acquired prior to the start of exterior work.

Although the above embodiment has been illustrated with respect to the case where identification information is input to each sensor device 18ᵢ through a display operating unit at the time of initial setting of each sensor device 18ᵢ, the time, method, and the like of inputting identification information to the sensor devices (or storing data in the RAM (memory)) are not particularly limited, but it is preferable that each sensor device used in the present embodiment output data containing an identification code (ID) of the sensor device. In the above embodiment, the identification code (ID) of each sensor device includes the identification code of a target object to which the sensor device is attached and the identification code of the attachment position on the target object, but may not include the identification code of the target object.

The above embodiment has been described with respect to the case where the on-site controller (the terminal device) 14 transmits sensor data regarding the same target object to the server 12 (the analysis device) in a batch based on IDs included in the plurality of pieces of sensor data output from the plurality of sensor devices 18ᵢ. However, instead of this, it is also possible to employ a configuration in which the analysis device extracts a plurality of pieces of sensor data regarding the same target object from a plurality of pieces of received sensor data based on IDs included in the sensor data and obtains shape information of the target object through calculation using information on inclination angles included in the plurality of pieces of extracted sensor data. In the present embodiment, the same number of sensor devices as the number of measurement points for acquiring inclination angle information are used, but the number of sensor devices does not necessarily have to be the same as the number of measurement points. In this case, inclination angle information at two or more measurement points may be acquired using one sensor device.

### Second Embodiment

In a second embodiment, a method of erecting a steel frame including a plurality of segment columns (steel columns) will be discussed as an example of how to use the shape acquiring method according to the first embodiment described above. Here, the same reference numerals are used for the same or equivalent components as in the first embodiment described above and detailed description thereof will be omitted.

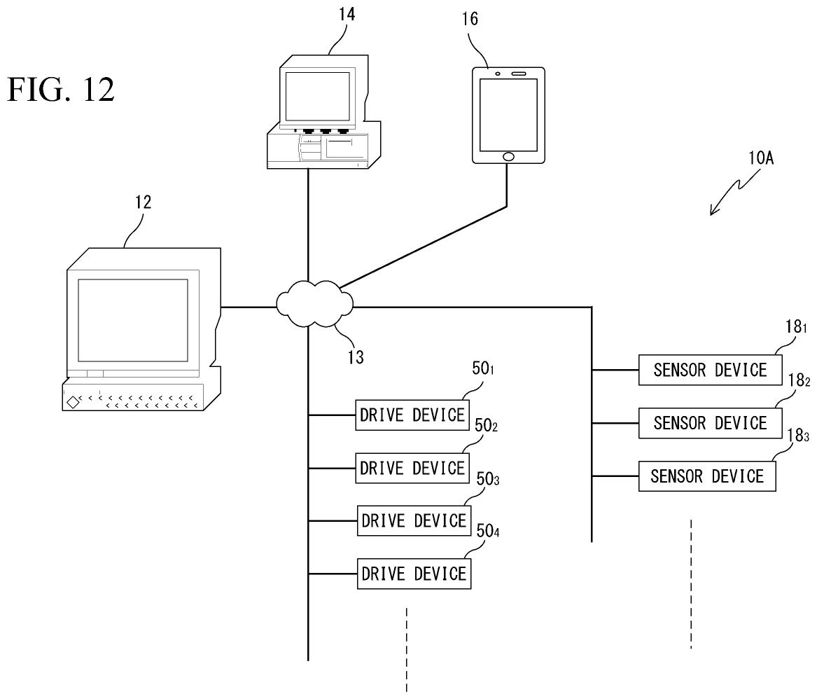

FIG. 12 shows an example of a configuration of a system 10A for implementing a method of erecting a steel frame.

The system 10A includes a server 12, an on-site controller 14, a mobile terminal 16, a plurality of sensor devices 18ᵢ (where i=1, 2, 3, . . . ), and a plurality of drive devices 50ₚ (where p=1, 2, 3, 4 . . . ) which are connected to each other via a network 13 such as the Internet. In FIG. 12, three sensor devices 18₁ to 18₃ are representatively shown among the plurality of sensor devices 18ᵢ and four drive devices 50₁ to 50₄ are representatively shown among the plurality of drive devices 50ₚ. Each of the plurality of sensor devices 18ᵢ and the plurality of drive devices 50ₚ is connected to the network 13 via a communication line such as a wireless LAN. The communication lines may all be wireless or may be at least partially wired. Each of the plurality of drive devices 50ₚ is individually attached to an erection jig 30ₚ (where p=1, 2, 3, 4 . . . ) that will be described later.

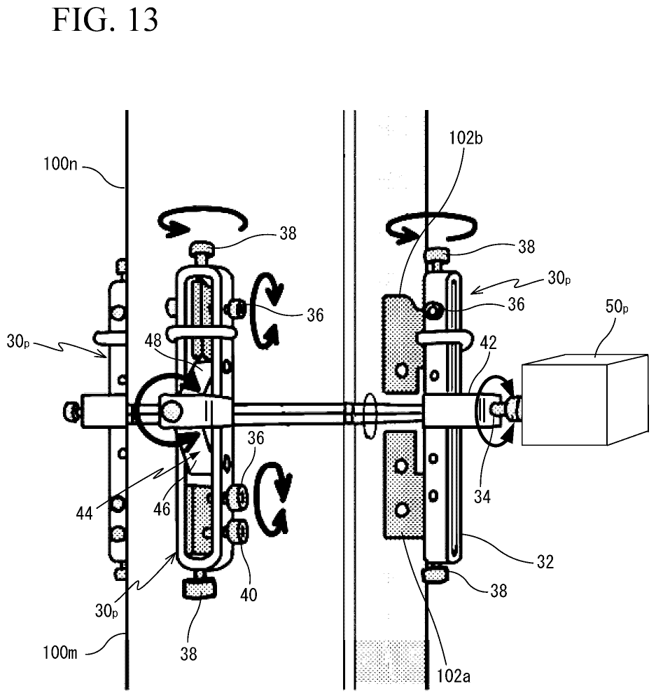

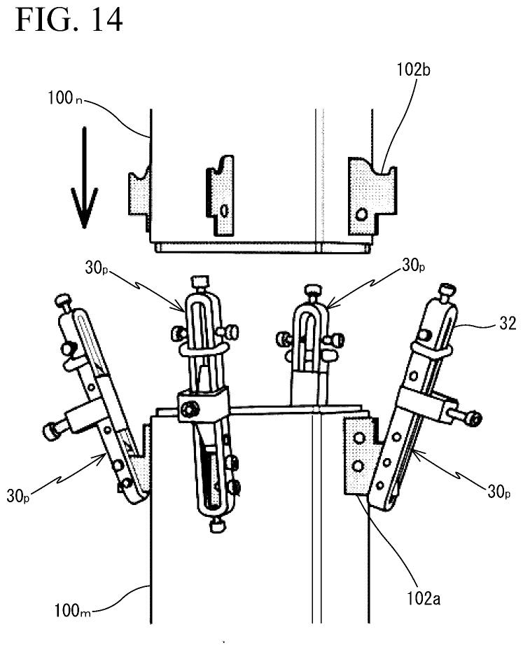

In the second embodiment, square columns having a rectangular cross section are used as columns 100 and four longitudinally extending surfaces of each column 100ⱼ are each provided with erection pieces 102 (102a and 102b) protruding respectively from a column head portion and a column base portion of the column 100ⱼ (see FIGS. 13 and 14). Each erection piece 102 is perpendicular to a corresponding surface of the column 100 and extends in the vertical direction. In the second embodiment, for convenience, each erection piece 102 provided at the column head portion is referred to as an erection piece 102a and each erection piece 102 provided at the column base portion is referred to as an erection piece 102b.

In the erection method, an erection piece 102a of a lower-segment column (hereinafter referred to as a lower segment column) 100ₘ and an erection piece 102b of an upper-segment column (hereinafter referred to as an upper segment column) 100ₙ erected on top of the lower segment column 100ₘ are connected to each other at each of the four surfaces extending in the longitudinal direction of the column using an erection jig 30ₚ as shown in FIG. 13.

As shown in FIG. 13, each erection jig 30ₚ includes a main body frame 32 and various parts provided on the main body frame 32 such as a tilt adjustment bolt 34, a misalignment adjustment bolt 36, a fall prevention bolt 38, and a fixing bolt 40. In the present embodiment, for example, hexagon socket head bolts are used as these bolts.

The main body frame 32 is a frame member that extends in a predetermined direction (a vertical direction in FIG. 13) and has a hollow portion wider than the thickness of the erection pieces 100a and 100b formed in the center in a width direction.

The fixing bolt 40 is a bolt for rotatably (swingably) attaching the erection jig 30ₚ to the erection piece to which it is to be attached. The fixing bolt 40 includes a head and a shaft and the shaft has a stepped cylindrical shape having a large diameter portion and a small diameter portion. The large diameter portion is provided at a portion on a head side of a shaft portion of the fixing bolt 40 and a threaded portion is formed on an outer circumferential surface of the large diameter portion and a side opposite to a head of the threaded portion, that is, a tip side, forms the small diameter portion.

When the erection jig 30ₚ is attached to the erection piece to which it is to be attached (the erection piece 102a in FIG. 13), the fixing bolt 40 is inserted from its tip side (the small diameter portion) into a screw hole formed near a lower end of one side surface of the main body frame 32 and the threaded portion is screwed into the screw hole. The small diameter portion of the fixing bolt 40 is inserted into a hole formed in the other surface of the main body frame 32 via a long hole formed in the erection piece 102a. With the erection jig 30ₚ being attached to the erection piece 102a, a tip of the small diameter portion is exposed outside the main body frame 32 by a predetermined amount. This allows the erection jig 30ₚ to be attached to the erection piece 102a to which it is to be attached while it can be rotated up and down around the axis of the fixing bolt 40 (see FIG. 14).

A push-up member 44 is disposed inside a central portion of the hollow portion of the main body frame 32 in the longitudinal direction. The push-up member 44 is located in a space between the erection piece 102a of the lower segment column 100ₘ and the erection piece 102b of the upper segment column 100 with the erection pieces 102b and 102a being connected by the erection jig 30ₚ (that is, with the erection jig 30ₚ being attached to the upper and lower segment columns) as shown in FIG. 13. The push-up member 44 includes a movable lever 46 whose one end (lower end in FIG. 13) is rotatably (swingably) supported by the main body frame 32 via a support pin and a push lever 48 whose one end is connected to a tip of the movable lever 46. The push lever 48 is rotatably connected to the movable lever 46. A through pin is attached to the other end (an upper end in FIG. 13) of the push lever 48 which is on the side opposite to the connecting portion. Both ends of the through pin are inserted into vertical guide holes formed in both side walls of the main body frame 32, such that the through pin can move up and down along the guide holes. The push-up member 44 is attached to the main body frame 32 while it is in a V-shape. When the connecting portion between the movable lever 46 and the push lever 48 are pressed, the overall shape of the push-up member 44 changes (deforms) such that the distance between the upper and lower ends of the push-up member 44 increases.

A support member 42 having a U-shaped cross section is fixed to the main body frame 32 such that the support member 42 covers the connecting portion between the movable lever 46 and the push lever 48. A screw hole is formed in one surface of the support member 42 and the tilt adjustment bolt 34 is screwed into the screw hole.

When the tilt adjustment bolt 34 is rotated (screwed) clockwise with the erection jig 30ₚ being attached to the upper and lower segment columns as shown in FIG. 13, the erection piece 102b of the upper segment column 100ₙ is pushed up by the push lever 48 of the push-up member 44. Other configurations of the push-up member such as a configuration using a cam may be considered and the configuration of the push-up member is not particularly limited.

The present embodiment may also employ a usage method in which the erection jig 30ₚ is attached to the upper and lower segment columns in an upside-down orientation from that of FIG. 13. Even in this case, when the tilt adjustment bolt 34 is rotated (screwed) clockwise, the erection piece 102b of the upper segment column 100ₙ is pushed up due to deformation of the push-up member 44.

A total of three misalignment adjustment bolts 36 are provided, one on either side of the upper half of the main body frame 32 in FIG. 13, and one on one side of the lower half of the main body frame 32. Each misalignment adjustment bolt 36 is screwed into the main body frame 32 through a screw hole. When the two misalignment adjustment bolts 36 in the upper half are rotated clockwise, their tips come into pressure contact with both sides of the erection piece 102b of the upper segment column, thus pressing the erection pieces 102b in opposite directions. Thus, when adjusting the misalignment, it is necessary to perform the adjustment while rotating the two misalignment adjustment bolts 36 in opposite directions. When one misalignment adjustment bolt 36 in the lower half is rotated clockwise, it presses one surface of the erection piece 102a of the lower segment column.

After the erection jig 30ₚ is attached to the erection pieces 102a and 102b to connect the upper and lower segment columns, the drive device 50ₚ is attached to the erection jig 30ₚ via a support member (not shown) as shown in FIG. 13. Specifically, the support member is configured such that it can be attached to the main body frame 32 without interfering with the operation of each of the bolts described above while it is in a posture in which relative displacement with respect to the main body frame 32 is unlikely to occur. A circular opening is formed in this support member at a position opposite to the top surface of a head of the inclination adjustment bolt 34 and one end of a hexagonal wrench-shaped member that is to be fitted into a hexagonal hole of the inclination adjustment bolt 34 is connected via the circular opening. The other end of the hexagonal wrench-shaped member is connected to a speed reduction mechanism included in the drive device 50ₚ via a rotating shaft. The speed reduction mechanism is connected to a motor included in the drive device 50ₚ. In the present embodiment, the drive device 50ₚ includes an MPU (a control microcomputer) and a motor and a sensor that measure the amount of rotation of the rotating shaft are electrically connected to the MPU.

In the present embodiment, four drive devices 50ₚ are individually attached to the main body frames 32 of the four erection jigs 30ₚ, which are disposed on the four surfaces of the lower segment column 100ₘ and the upper segment column 100ₙ and connect the erection pieces 102a and 102b, via support members (not shown).

The MPU of each drive device 50ₚ is connected to the network 13 via a communication unit.

In the present embodiment, the amount of rotation of the motor included in each drive device 50ₚ is controlled in accordance with a command value given from an external terminal, for example, the server 12, via the network 13. Of course, control of the amount of rotation of the motor, that is, adjustment of the inclination adjustment bolt 34, is performed accurately since the amount of rotation is measured by the sensor included in each drive device 50ₚ.

A detailed configuration of a steel column inclination adjustment device which has the same structure as the erection jig 30ₚ is disclosed, for example, in Japanese Patent Application, Publication No. 2001-355340. A further detailed description of the erection jig 30ₚ will be omitted.

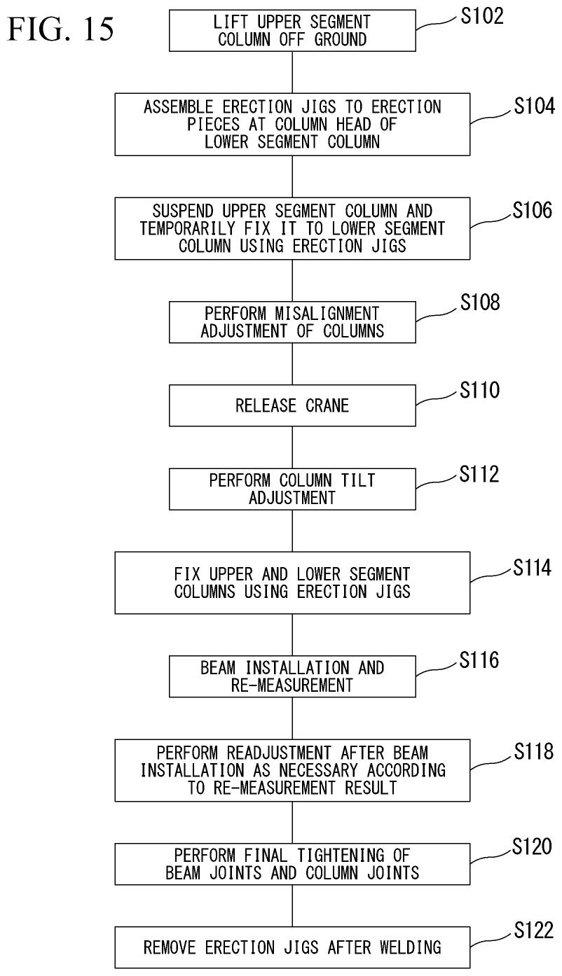

Next, a method of erecting a steel frame will be described with reference to the flowchart of FIG. 15, focusing on a method of erecting nth segment steel members (where n≥2) (hereinafter referred to as nth segment columns as appropriate). FIG. 15 shows a process flow of a method of erecting nth segment columns. A prerequisite for starting the method of erecting nth segment columns is that the method of erecting (n−1)th segment columns has been completed. Here, as a premise, it is assumed that lower segment columns ((n−1)th segment columns in this case) 100ₘ have been erected vertically.

First, in step S102, an upper segment column (in this case, the nth segment column) 100ₙ is lifted off the ground by a crane.

In the next step S104, an erection jig 30ₚ is assembled (attached) to each erection piece 102a at a column head of a lower segment column 100ₘ (or each erection piece 102b at a column base of the upper segment column 100ₙ). Four erection jigs 30ₚ are assembled respectively to the erection pieces 102a on the four surfaces (see FIG. 14).

In the next step S106, the upper segment column 100ₙ is suspended by a crane and temporarily fixed to the lower segment column 100ₘ using the erection jigs 30ₚ. That is, the upper segment column 100ₙ is suspended, and with the four erection jigs 30ₚ attached to the erection pieces 102a at the column head of the lower segment column 100ₘ (or the erection pieces 102b at the column base of the upper segment column 100) being opened (see FIG. 14), the upper segment column 100ₙ is placed on top of the lower segment column 100ₘ and the erection pieces 102b of the upper segment column 100ₙ (or the erection pieces 102a of the lower segment column 100ₘ) are wrapped with the main body frames 32 of the four erection jigs 30ₚ, and then the four pairs of erection pieces 102a and 102b provided at the column base of the upper segment column 100ₙ and the column head of the lower segment column 100ₘ are connected using the four erection jigs 30ₚ.

In the next step S108, misalignment of the columns is adjusted. Misalignment refers to misalignment in the horizontal plane between the column head of the lower segment column 100ₘ and the column base of the upper segment column 100ₙ. Adjustment for this misalignment is performed by adjusting the position of the upper segment column 100ₙ in the X axis direction and the Y axis direction with respect to the lower segment column 100ₘ such that the upper and lower segment columns appear to be one column, for example, by visually adjusting the directions of rotation and the amounts of rotation of the plurality of misalignment adjustment bolts 36 of each of the four erection jigs 30ₚ, with the upper segment column 100ₙ being placed on top of the lower segment column 100ₘ while the upper segment column 100ₙ is suspended by the crane. With this adjustment, the erection pieces 102a of the lower segment column 100ₘ and the erection pieces 102b of the upper segment column 100ₙ are positioned substantially in vertical lines on the four surfaces. That is, misalignment adjustment can also mean adjusting the positional deviation of the upper segment column 100ₙ in the X axis direction and the Y axis direction with respect to the lower segment column 100ₘ by adjusting the directions of rotation and the amounts of rotation of the plurality of misalignment adjustment bolts 36 of each of the four erection jigs 30ₚ such that the erection pieces 102a of the lower segment column 100ₘ and the erection pieces 102b of the upper segment column 100ₙ are positioned substantially in vertical lines on the four surfaces.

After this, the crane is released (step S110). When the weight of a column is lighter than a predetermined value, it is also possible to release the crane before performing the misalignment adjustment.

In the next step S112, column tilt adjustment is performed. In the present embodiment, this tilt adjustment is automatically performed by the server 12 and the MPUs of the drive devices 50ₚ attached to the four erection jigs 30ₚ.

This will be described in further detail. Tilt adjustment of an upper segment column 100ₙ which has the same arrangement as the column 100 shown in FIG. 11 and has six sensor devices 18ᵢ attached thereto will be described as an example.

The server 12 instructs the six sensor devices 18ᵢ attached to the upper segment column 100ₙ to start measurement and acquires sensor data from the six sensor devices 18ᵢ.

Next, the server 12 obtains shape information of a first surface of the upper segment column 100ₙ using the method described above based on sensor data output from the three sensor devices 18ᵢ attached to the first surface of the upper segment column 100ₙ. The server 12 also obtains shape information of a second surface of the upper segment column 100ₙ using the method described above based on sensor data output from the three sensor devices 18ᵢ attached to the second surface of the upper segment column 100ₙ. Here, the server 12 manages the relationship between an ID included in sensor data of each sensor device 18ᵢ and a column to which the sensor device 18ᵢ is attached and the attachment position of the sensor device 18ᵢ (that is, the measurement point of the sensor device).

The sensor devices 18ᵢ are attached to the column 100 before or after the column 100 is erected, a mark is attached to the attachment position, and the position of the mark is determined by the server 12 based on design information. Similar to the first embodiment described above, information as to which sensor device 18ᵢ is attached (or has been attached) at which position on which column may be input by a worker in charge of attaching the sensor device 18ᵢ when performing initial setting of the sensor device 18ᵢ and the information input during the initial setting may be included in the sensor data as ID information. Alternatively, information on the column number and attachment position of the sensor device 18ᵢ may be input to the arithmetic processing unit 182 and stored in the memory in advance at the time of shipping the sensor device 18ᵢ and information on the column number and attachment position may be displayed on the screen of the display operating unit 187.

Next, the server 12 obtains the amount of positional deviation (Δx, Δy) of the column head of the upper segment column 100ₙ from the reference in the X axis direction and the Y axis direction based on the shape information of the first and second surfaces of the upper segment column 100 and adjusts the inclination angle of the upper segment column 100ₙ using the four erection jigs 30ₚ such that the amount of positional deviation is approximately zero (or is within a predetermined tolerance). This adjustment is realized by the server 12 converting the amount of positional deviation (Δx, Δy) into an inclination angle of the upper segment column 100ₙ and giving the MPUs of the four drive devices 50ₚ command values for the amounts of control of the motors for canceling the inclination angle to control the rotations of the inclination adjustment bolts 34 of the four erection jigs 30ₚ in parallel. In the present embodiment, the rotations of the inclination adjustment bolts 34 of the four erection jigs 30ₚ can be controlled in parallel and therefore inclination angle adjustment of the upper segment column 100 can be performed quickly and accurately compared to the case where rotation adjustment of the inclination adjustment bolts 34 of the four erection jigs 30ₚ is performed one by one in order by the joint work of a plurality of people as in the related art.

In the next step S114, the upper segment column 100ₙ and the lower segment column 100ₘ are fixed using the erection jigs 30ₚ. This fixing is performed by temporarily tightening (lightly tightening) the fixing bolts 40 and the fall prevention bolts 38 of the four erection jigs 30ₚ using a special tool.

The processes from steps S102 to S114 described above are performed sequentially (or partially in parallel) for a plurality of upper segment columns (nth segment columns) 100ₙ.

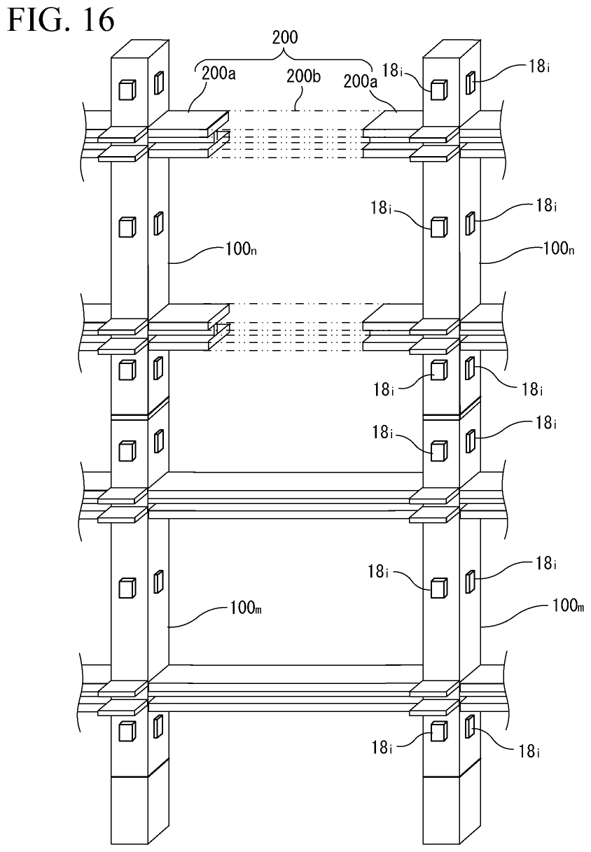

FIG. 16 shows a state in which the process up to step S114 has been completed for a plurality of upper segment columns (nth segment columns) 100ₙ with some parts omitted. In FIG. 16, illustration of the erection jigs is also omitted.

In the next step S116, beam installation and re-measurement after beam installation are performed. Here, beam installation generally refers to placing a steel beam member between two columns and connecting both ends of the steel beam member to the two columns. A steel beam member (a steel beam) used in the present embodiment is a beam 200 including a pair of beam end members 200a which are located at both ends of the steel beam and joined to the columns 100 and a beam central member 200b (indicated by a double-dashed line in FIG. 16) which is joined at one end and the other end thereof to the pair of beam end members 200a as shown in FIG. 16. Thus, in the present embodiment, beam installation means that a central member 200b is arranged between two beam end members 200a joined to two columns 100 and the central member 200b and the beam end members 200a on both sides thereof are connected to each other by beam joints. However, due to manufacturing errors that inevitably exist in steel beam members, the inclination angle of the columns 100 may change from before the beam installation by a horizontal force acting on the columns 100 connected to both ends of the steel beam member during the beam installation. To check this change, it is necessary to re-measure the inclination angle after the beam installation.

Reference is now made back to FIG. 15. In the next step S118, readjustment after beam installation is performed as necessary according to the result of the re-measurement. Readjustment after beam installation may include misalignment adjustment of columns and tilt adjustment of columns. The misalignment adjustment of columns is performed by visually adjusting the amounts of rotation and the directions of rotation of the plurality of misalignment adjustment bolts 36 of each of the four erection jigs 30ₚ as described above. On the other hand, the tilt adjustment of columns is performed automatically. Specifically, the tilt adjustment is automatically performed for the plurality of upper segment columns 100ₙ to be adjusted in parallel by the server 12 and the MPUs of the drive devices 50ₚ attached to the four erection jigs 30ₚ used to connect the plurality of upper and lower segment columns in the same manner as in step S112 described above. Thereby, the inclination errors of the plurality of upper segment columns 100ₙ to be adjusted are adjusted at once to be almost zero (or to be within a predetermined tolerance).

In the next step S120, the beam joints and column joints are finally tightened. The final tightening of beam joints is performed by tightening high-strength bolts of the beam joints and the final tightening of column joints is performed by finally tightening the fall prevention bolts 38 and the fixing bolts 40 of the four erection jigs 30ₚ (and the misalignment adjustment bolts 36 as necessary). After this final tightening, the inclination angles of the upper segment columns 100ₙ are measured to confirm that the inclination errors are within a predetermined tolerance. Here, the tolerance is different from a specification value (a positional deviation of a column head within 10 mm in a 10 m long steel member) and is set to a value smaller than the specification value and larger than zero. Here, the inclination errors of the columns are usually within the predetermined tolerance since the inclination errors have been automatically adjusted to be almost zero (or within the predetermined tolerance) in the step of readjustment (step S118) described above.

After a predetermined period of time elapses, the upper segment column 100ₙ is welded to the lower segment column 100ₘ and then the four erection jigs are removed (step S122). After that, the erection pieces are cut. Even after welding, the inclination angles of the upper segment columns 100ₙ are measured for the purpose of confirming that the inclination angles of the upper segment columns 100ₙ are within the tolerance. Here, the inclination errors of the upper segment columns 100ₙ are normally within the tolerance since it has been confirmed in step S120 that the inclination errors are within the tolerance. However, the inclination error of an upper segment column 100n, that is, the amount of positional deviation of a column head, may not be within the tolerance since a considerable amount of time elapses after the final tightening is completed until welding starts. In such a case, readjustment is no longer possible since welding has been completed, but the measurement result of the inclination angle can be effectively used in subsequent steps. Based on the measurement result of the inclination angle, it is possible, for example, to set an offset for canceling (the influence of) the inclination error in a target value for erectness (of the column head position) of an upper segment column (an (n+1)th segment column here).

The description so far has been based on the assumption that the lower segment columns 100ₘ are erected vertically. However, in reality, even if lower segment columns 100ₘ were vertical at the end of erection, the lower segment columns 100ₘ may not be vertical when the erection of upper segment columns 100ₙ begins due to the fact that a certain amount of time has elapsed from the completion of the erection of the lower segment columns 100ₘ to the start of the erection of the upper segment columns 100ₙ.

Therefore, when individually erecting a plurality of upper segment columns 100ₙ on top of a plurality of lower segment columns 100ₘ erected in a predetermined arrangement, shape information of a first surface and a second surface of each of the plurality of lower segment columns 100ₘ, the first and second surfaces intersecting each other (for example, being orthogonal to each other) and extending in a longitudinal direction, may be acquired using a plurality of sensor devices 18ᵢ, a first amount of positional deviation from a reference of a column head in a direction (the Y axis direction) perpendicular to the first surface and a second amount of positional deviation in a direction (the X axis direction) perpendicular to the second surface of each of the plurality of lower segment columns 100ₘ may be obtained based on the acquired shape information, and a target value for the erectness of the plurality of upper segment columns 100ₙ may be newly determined taking into account the first amount of positional deviation and the second amount of positional deviation. In this case, for example, the target value for erectness of the upper segment columns can be newly determined such that the first amount of positional deviation and the second amount of positional deviation are canceled out.

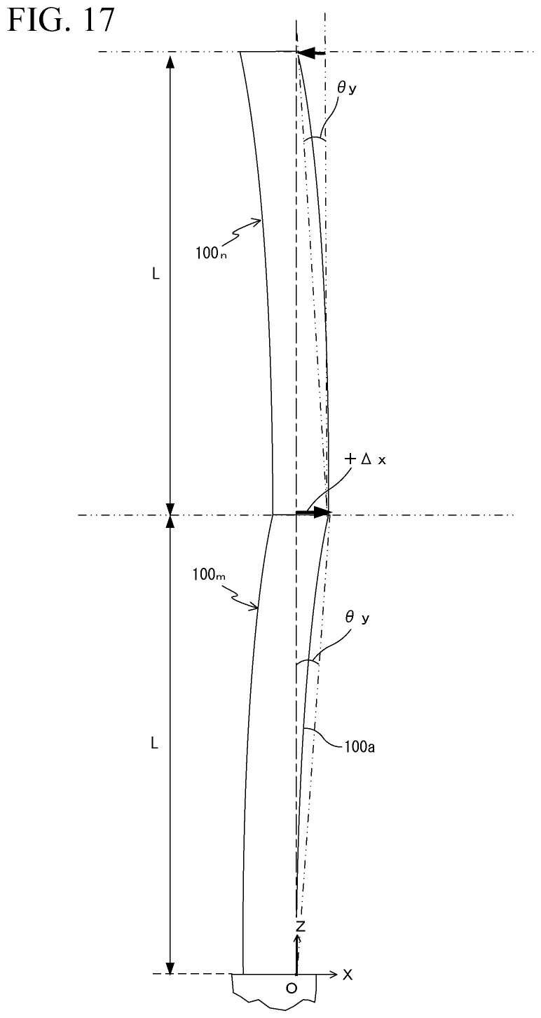

Here, the new setting of a target value for erectness of a second segment column 100 for canceling the amount of positional deviation in the X axis direction of a column head of a first segment column 100ₘ when erecting the second segment column 100ₙ on top of the first segment column 100ₘ will be described based on FIG. 17 as an example.

It is assumed that the amount of positional deviation of the column head of the first segment column 100ₘ in the X axis direction obtained from the shape of a first surface 100a of the first segment column 100ₘ calculated using sensor data from three sensor devices 18ᵢ attached to the first surface 100a of the first segment column 100ₘ which is a lower segment column is +Δx (see FIG. 17). In reality, this Δx is smaller than the specification value and thus is smaller than 10 mm in the case of a 10 m long steel column. Curved shapes of the first segment column 100ₘ and the second segment column 100ₙ in FIG. 17 are drawn considerably exaggerated for convenience of explanation.

When the length of each of the first segment column 100ₘ and the second segment column 100ₙ is L, +Δx/L=tan θy holds true as shown in FIG. 17 and this can be rewritten as +Δx=L·tan θy. Thus, to cancel this, −Δx=L·tan(−θy) is newly set as a target position of the column head of the second segment column 100ₙ in the X axis direction.

As is clear from FIG. 17, newly setting the target position of the column head of the second segment column 100ₙ in the X axis direction substantially (consequently) coincides with setting the target value of the inclination (inclination angle) of the second segment column 100ₙ to (−θy). Here, it is assumed that θy is positive in the clockwise direction. θy indicates an overall inclination of the column around the Y axis (the inclination, with respect to the Z axis in the XZ plane, of a straight line connecting a lower end and an upper end of the first surface of the column), rather than the inclination angle βᵢ of the first surface of the column at each measurement point measured by the sensor device 18ᵢ.

Thus, obtaining a position of the column head (an amount of positional deviation) in the X axis direction of the first segment column (the lower segment column) 100ₘ from the shape of the first surface of the first segment column 100ₘ and obtaining an inclination θy from the position of the column head (the amount of positional deviation) and then newly setting an inclination angle (−θy) for canceling the inclination θy as a target value for erectness (a target value of the inclination angle) of the second segment column (the upper segment column) 100ₙ results in newly setting a target position in the X axis direction of the column head of the second segment column 100ₙ for canceling the amount of positional deviation +Δx=L·tan θy described above.

New setting of a target value for erectness of the second segment column 100ₙ for canceling the amount of positional deviation of the column head in the Y axis direction of the first segment column 100ₘ can also be performed in the same manner as described above. In some cases, the amount of positional deviation of the column head of the first segment column 100ₘ in one of the X axis direction and the Y axis direction may be zero. In such a case, a new target value for erectness (a new target value for the inclination angle) of the second segment column (the upper segment column) 100ₙ may be set only in the other of the X axis direction and the Y axis direction.

When positioning the column head of the second segment column (the upper segment column) 100ₙ at a target position in the X axis direction and the Y axis direction of the second segment column 100ₙ which has been newly set for canceling the amount of positional deviation in the X axis direction and the Y axis direction of the first segment column 100ₘ is realized using the method of automatic adjustment of the inclination adjustment bolts 34 described above, the server 12 may give the MPUs of the four drive devices 50ₚ, which are attached to the erection jigs 30ₚ used to fix the upper and lower segment colunms, command values for the amounts of control of the motors for canceling the amount of positional deviation of the column head of the first segment column 100ₘ. In this case, if sensor devices 18ᵢ are attached to the second segment column 100ₙ similar to the first segment column 100ₘ, the server 12 may obtain the shapes of the first surface and the second surface and the position of the column head in the X axis direction and the Y axis direction of the second segment column 100ₙ based on information on an inclination angle measured using the sensor devices 18ᵢ and performs automatic adjustment of the inclination adjustment bolts 34 such that there is no difference between the obtained position and the target position described above. Performing such an adjustment can reliably position the column head of the second segment column 100ₙ at the target position since the first segment column 100ₘ and the second segment column 100ₙ do not necessarily deform in the same way.

Although the second embodiment has been exemplified by square columns as a type of steel columns, they may also be cylindrical columns. The steel column may also be a steel column made of H steel or I steel combined in a cross shape.

Also, in the second embodiment, the position of the column head of the column in the XY plane (the column tilt) is automatically adjusted through the four erection jigs 30ₚ (that is, the rotation of the tilt adjustment bolts 34 of each of the four erection jigs 30ₚ is automatically adjusted) based on the shape or position information of the column obtained from output data (sensor data) of the sensor devices 18ᵢ. However, in addition to this, column misalignment or the like may be automatically adjusted based on the position information of the column obtained from the output data of the sensor devices 18ᵢ. For example, the shape and structure of a support member (not shown) on which the drive device 50ₚ is mounted may be changed to a shape and structure with which it is also possible to mount an adjustment device that can adjust the directions of rotation and the amounts of rotation of the misalignment adjustment bolts 36 or a support member separate from the support member on which the drive device 50ₚ is mounted may be provided and the adjustment device may be mounted on the separate support member. In any case, it is also possible to automatically adjust the misalignment of columns by adopting a configuration in which the server 12 controls the adjustment device.

Although the first embodiment above discusses a steel column as a target object to describe the calculation of the shape of the target object and the management of the maximum amount of displacement (corresponding to the maximum amount of deflection) and the management of changes over time using the calculated shape. The shape acquiring method and the shape acquiring system according to the first embodiment (hereinafter abbreviated as a method and system according to the first embodiment) can also be applied to management of steel members other than steel columns (management of absolute values and/or management of changes over time) and also to other construction process management. Also, although each sensor device is fixed to a steel column using a magnet (a magnetic force) in the first embodiment, other fixing means may be used instead of or in addition to a magnet. For example, if the target object is a member that can be secured with sufficient strength by screwing such as, for example, a metal, the sensor device may be fixed to the target object using screws (including bolts) instead of or in addition to a magnet. Also, the sensor device may be fixed to the target object using an adhesive depending on the material of the target object. Target objects are not limited to those of the above embodiment (steel columns of a building or the like) and may be other infrastructures such as, for example, bridges, dams, tunnels (including structures such as inner walls or jet fans installed in tunnels), expressways, elevated roads, plants (including tanks or the like), or indoor facilities (indoor pools, gymnasiums, or halls) or may be wind turbine blades for wind power generation, aircraft fuselages, wings, or propellers, car bodies (especially, lead cars) of a high-speed railway (such as Shinkansen), railway rails, ships (for example, ship hulls or propellers), or the like. In addition to these, target objects may be vehicles (such as automobiles such as F1 cars, airplanes, trains, or ships), underwater vehicles (such as submarines or deep-sea exploration vessels), space-related objects (such as spacecrafts or reentry bodies), flying objects (such as rockets, missiles, or satellites), power plants (such as hydroelectric, thermal, natural gas, or nuclear plants), or the like.

Examples of construction process management to which the method and system according to the first embodiment can be suitably applied include pile driving management (management of absolute values and/or management of changes over time), retaining wall management (management of changes over time), and the like. Here, the term “pile” refers to a structure that serves as a foundation for construction and the term “retaining wall” refers to a wall that restrains the surrounding soil and sand when digging a hole to make an underground structure.

The method and system according to the first embodiment can also be applied to infrastructure management. For example, the method and system according to the first embodiment can be suitably applied to bridge maintenance (management of changes over time), bridge construction management (management of absolute values), dam wall maintenance (management of changes over time), tunnel maintenance (management of changes over time), and plant/gas tank maintenance (management of changes over time). The method and system according to the above embodiments can also be applied to various other types of deformation analysis. The method and system according to the above embodiments can be suitably applied, for example, to analysis of ship bottom deformation (changes over time), analysis of wind power generation blade deformation (changes over time), analysis of unmanned aircraft wing deformation (changes over time), and analysis of railway rail deformation (changes over time).

When the method and system according to the first embodiment are applied to bridge maintenance, for example, a plurality of sensor devices are placed on a bridge and changes in its three-dimensional shape from an initial state are constantly monitored, and for example when an index of change (for example, an inclination angle, a maximum amount of displacement, or the like output by a sensor device) exceeds a threshold value, the server 12 issues an alarm to the on-site controller 14. This allows the manager of the on-site controller 14 to quickly recognize the occurrence and location of an abnormality, thereby eliminating the need for periodic inspections by workers and making it possible to implement efficient inspections.

The manager of the server 12 does not particularly matter as long as the manager of the server 12 shares design data or the like of a structure including a target object (a column in the above embodiment) on which sensor devices are installed with the manager of the on-site controller 14. For example, the server 12 may be under the control of a user of the sensor devices such as a construction company or may be under the control of a supplier of the sensor devices (such as a manufacturer or a supplier). The server may also be a cloud. If the server 12 is under the control of a supplier of the sensor devices, the supplier leases (or rents) sensor devices to users and provides them with optimal information acquired in advance such as the attachment positions of the sensor devices determined based on the purpose of use. The supplier receives data that the users have acquired with the sensor devices based on that information, performs specified analysis (including shape calculation) using the received data, and provides information on the analysis results to the users. Then, the supplier receives fees from the users for leasing (or renting) the sensor devices and providing information. Such a business method (business model) can also be realized. In this case, instead of providing analysis and analysis results, application software (application program) for analysis processing may be leased together with the sensor devices.

### REFERENCE SIGNS LIST

10 Shape acquiring system
12 Server
13 Wide area network
14 On-site controller
16 Mobile terminal
18₁-18₃ Sensor device
100 Steel column
110 Steel building
181 Angle sensor
182 Arithmetic processing unit
183 Wireless communication unit
184 Power supply unit
185 Housing
187 Display operating unit
188 Cushion member
190 Permanent magnet

1. A shape acquiring method of acquiring shape information about a target object, the method comprising:
acquiring information on inclination angles of a target object at a plurality of points using a plurality of sensors attached to the target object; and
obtaining shape information of the target object through calculation using the acquired information on the inclination angles at the plurality of points.

2. The shape acquiring method according to claim 1, wherein the target object is a steel column erected at a construction site.

3. The shape acquiring method according to claim 2, wherein the acquiring includes acquiring information on first inclination angles at a plurality of points spaced apart in a longitudinal direction of the steel column on one surface extending in the longitudinal direction, and
the obtaining includes obtaining shape information of the one surface of the steel column through calculation using the information on the plurality of first inclination angles.

4. The shape acquiring method according to claim 3, wherein the acquiring includes further acquiring information on second inclination angles at a plurality of points spaced apart in the longitudinal direction on another surface intersecting the one surface of the steel column, and
the obtaining includes further obtaining shape information of the another surface of the steel column using the information on the plurality of second inclination angles.

5. The shape acquiring method according to claim 1, wherein the target object includes at least one of a building, a bridge, a tunnel, a dam, a wind turbine, an aircraft, a high-speed railway, and a ship.

6. The shape acquiring method according to claim 1, further comprising obtaining a point where a maximum amount of displacement from a reference of a part of the target object occurs and the maximum amount of displacement based on the obtained shape information.

7. The shape acquiring method according to claim 1, wherein the plurality of sensors are configured to measure information on the inclination angles with respect to a direction of gravity.

8. A method of managing a target object, the method comprising:
repeatedly performing the shape acquiring method according to claim 1; and
monitoring a change in a shape of the target object over time based on shape information obtained each time the shape acquiring method is performed.

9. A method of erecting a steel frame including a plurality of segment columns, the method comprising:
when individually erecting a plurality of upper segment columns on top of a plurality of lower segment columns erected in a predetermined arrangement, acquiring shape information of one surface extending in a longitudinal direction of each of the plurality of lower segment columns using the shape acquiring method according to any claim 1;
obtaining a first amount of positional deviation from a reference of a column head in a direction perpendicular to the one surface of each of the plurality of lower segment columns based on the acquired shape information; and
newly determining a target value for erectness of each of the plurality of upper segment columns taking into account the obtained first amount of positional deviation.

10. The method according to claim 9, wherein, in the determining, the target value for erectness of each of the plurality of upper segment columns is newly determined so that the first amount of positional deviation is canceled.

11. The method according to claim 9, wherein the acquiring includes further acquiring shape information of another surface extending in the longitudinal direction and intersecting the one surface of each of the plurality of lower segment columns using the shape acquiring method,
the obtaining includes further obtaining a second amount of positional deviation from the reference of the column head in a direction perpendicular to the another surface of each of the plurality of lower segment columns acquired, and
the determining includes newly determining a target value for erectness of each of the plurality of upper segment columns by further taking into account the second amount of positional deviation of the column head of each of the plurality of lower segment columns.

12. The method according to claim 11, wherein the determining includes newly determining a target value for erectness of each of the upper segment columns to cancel the first amount of positional deviation and the second amount of positional deviation.

13. A method of erecting a steel frame including a plurality of segment columns, the method comprising:
when individually erecting a plurality of upper segment columns on top of a plurality of lower segment columns erected in a predetermined arrangement, connecting the plurality of lower segment columns and the plurality of upper segment columns respectively, by using a plurality of erection jigs respectively;
acquiring shape information of a first surface and a second surface extending in a longitudinal direction and intersecting each other of each of the plurality of upper segment columns using the shape acquiring method according to claim 4; and
controlling, by a control device, a plurality of drive devices individually provided for the plurality of erection jigs in parallel based on the acquired shape information of the first surface and the second surface of each of the plurality of upper segment columns to automatically adjust positions of column heads of the plurality of upper segment columns.

14. The method according to claim 13, wherein an erection piece is provided at each of a column head portion and a column base portion on each of four surfaces extending in the longitudinal direction of each of the columns, and
the erection piece at the column head portion of the lower segment column and the erection piece at the column base portion of the upper segment column on each of the four surfaces are connected using a corresponding one of the plurality of erection jigs to connect the upper and lower segment columns.

15. The method according to claim 13, wherein each of the plurality of erection jigs has a tilt adjustment mechanism, a misalignment adjustment mechanism, and a fall prevention mechanism, and
each of the drive devices is used for adjustment of at least the tilt adjustment mechanism.

16. A shape acquiring system for acquiring shape information of a target object, the shape acquiring system comprising:
an analysis device and a terminal device connected to each other via a wide area network; and
a plurality of sensor devices each connected to the terminal device via a communication line, the plurality of sensor devices being attached to different positions on the target object when used, each of the plurality of sensor devices being configured to output sensor data including information on an inclination angle at a corresponding attachment position via the communication line,
wherein each of the plurality of sensor devices is configured to output the sensor data based on an external command or at a predetermined time,
the terminal device is configured to transmit the sensor data output from each of the plurality of sensor devices to the analysis device via the wide area network, and
the analysis device is configured to obtain shape information of the target object through calculation using the information on the inclination angle included in the plurality of pieces of sensor data received via the wide area network and store the obtained shape information in a storage.

17. The shape acquiring system according to claim 16, further comprising a mobile terminal connected to the wide area network, the mobile terminal being configured to be capable of wireless communication with the plurality of sensor devices.

18. The shape acquiring system according to claim 16, wherein the external command is given from the terminal device via a communication line.

19. The shape acquiring system according to claim 16, wherein the sensor data includes an ID for identifying each of the sensor devices.

20. The shape acquiring system according to claim 19, wherein the ID includes an identification code of each of the sensor devices and an identification code of an attachment position on the target object.

21. The shape acquiring system according to claim 19, wherein the target object includes a plurality of target objects and the ID further includes an identification code of a target object to which each of the sensor devices is attached,
the terminal device is configured to transmit the sensor data regarding the same target object to the analysis device in a batch based on the ID included in the plurality of pieces of sensor data output from the plurality of sensor devices, and
the analysis device is configured to obtain shape information of the target object through calculation using the information on the inclination angle included in the received batch of sensor data regarding the same target object.

22. The shape acquiring system according to claim 19, wherein the target object includes a plurality of target objects and the ID further includes an identification code of a target object to which each of the sensor devices is attached, and
the analysis device is configured to extract a plurality of pieces of sensor data regarding the same target object from a plurality of pieces of received sensor data based on an ID included in the sensor data and obtain shape information of the target object through calculation using the information on the inclination angle included in the plurality of pieces of extracted sensor data.

23. The shape acquiring system according to claim 16, wherein each of the sensor devices includes a housing, an inclination sensor, an arithmetic processing unit, and a wireless communication unit housed in the housing, and a power supply unit.

24. The shape acquiring system according to claim 23, wherein the housing is provided with a display operating unit connected to the arithmetic processing unit.

25. The shape acquiring system according to claim 23, wherein the target object is a steel column erected at a construction site.

26. The shape acquiring system according to claim 25, wherein each of the plurality of sensor devices is fixed to the steel column by a magnetic force of a magnet embedded in one surface of the housing.

27. The shape acquiring system according to claim 26, wherein each of the plurality of sensor devices is fixed to the steel column via a cushion member disposed on the one surface of the housing.

28. The shape acquiring system according to claim 25, wherein the plurality of sensor devices are attached to one surface extending in a longitudinal direction of the steel column at a plurality of points thereon spaced apart in the longitudinal direction, each of the plurality of sensor devices being configured to output the sensor data, and
the analysis device is configured to obtain shape information of the one surface of the steel column through calculation using the information on the inclination angle included in a plurality of pieces of sensor data.

29. The shape acquiring system according to claim 28, wherein the analysis device is configured to further obtain a maximum amount of displacement from a reference of the one surface based on the obtained shape information and store the obtained maximum amount of displacement in the storage.

30. The shape acquiring system according to claim 16, wherein the analysis device is configured to transmit information stored in the storage to the terminal device via the network, and
the terminal device is configured to receive the information transmitted from the analysis device and store the received information in a storage device included in the terminal device.

31. The shape acquiring system according to claim 16, wherein the analysis device is configured to be under control of a supplier of the sensor device and the terminal device is configured to be under control of a user of the sensor device.

32. The shape acquiring system according to claim 16, wherein the information on the inclination angle included in the sensor data is information on an inclination angle with respect to a direction of gravity.

33. The shape acquiring system according to claim 16, wherein each of the plurality of sensor devices is configured to repeatedly output the sensor data including the information on the inclination angle to the terminal device at preset intervals, and
the analysis device is configured to repeatedly obtain shape information of the target object through calculation using the information on the inclination angle included in the plurality of pieces of sensor data regarding the target object received via the wide area network at times corresponding to an interval of output from the terminal device and store the obtained shape information in the storage each time the shape information is obtained.
